(19) United States
(12) Patent Application Publication
(10) Pub. No.: US 2011/0114718 A1
(43) Pub. Date: May 19, 2011

(54) SECURE PARTITIONING

(76) Inventors: Mark Wilds, Cambridge (GB); Peter Kelly, Cambridge (GB); Stephen McSpadden, East Kilbride (GB)

(21) Appl. No.: 12/865,077

(22) PCT Filed: Jan. 30, 2009
(86) PCT No.: PCT/GB2009/000274

§ 371 Date: Jan. 25, 2011

(30) Foreign Application Priority Data
Feb. 1, 2008 (GB) 0801811.1

(51) Int. Cl. G06K 5/00; G06F 17/00

(52) U.S. Cl. 235/375

(57) ABSTRACT

A brand protection feature/taggant reader and/or writer instrument comprising a secure processing environment and a non-secure processing environment, the instrument being operable to execute a process that is split between the secure and non-secure environments in accordance with pre-defined criteria.

The present invention relates to a method and apparatus for enforcing security in a brand protection management system (BPMS). In particular, the present invention relates to a security feature reader/writer with an integrated secure processing environment, such as a secure application module.

### BACKGROUND OF THE INVENTION

PCT/GB2007/001248, the contents of which are incorporated herein by reference, describes a brand protection management system. In this, goods are provided with machine-readable tags that contain authentication information. The authentication information is read from the tags using a tag reader and compared with stored authentication data, thereby to determine the authenticity or otherwise of the goods. Security of the authentication process is essential.

### SUMMARY OF THE INVENTION

According to a first aspect of the present invention, there is provided a brand protection/taggant reader and/or writer instrument for use in a brand protection management system, the instrument having a secure processing environment and an insecure processing environment, the instrument being operable to split an operation between the secure and insecure environments in accordance with a defined procedure. The operation may be at least one of authentication of a brand protection feature/taggant and issuing or registration of a brand protection feature/taggant.

By delegating a subset of secure functions to a secure processing environment, such as a secure application module (SAM), key steps can be secured, whilst allowing the bulk of a process to be run in a rich, open software environment, such as provided by .NET or a Java Virtual Machine.

The instrument may be a reader for reading a security feature and/or writer for writing the security feature. The operation may be to check whether a scanned security feature, for example a machine-readable tag, is authentic. Additionally or alternatively, the operation may involve the issuing of a security feature, such as a machine-readable tag.

The instrument may be operable to read one or more types of machine readable taggants/brand protection features. Such taggants may, for example, include barcodes, one dimensional or two dimensional, RFID tags, fluorescent tags, or any other suitable taggant types.

In most cases the machine readable brand protection features/taggants will be physically attached to, or otherwise incorporated in, the articles to be authenticated.

In some cases the brand protection feature/taggant may comprise an inherent feature of the article itself which the brand protection feature/taggant instrument is configured to read, e.g. a visible or covert feature which the reader means is designed to detect/read.

For the avoidance of doubt, it will be understood that the terms “brand protection feature” or “taggant” as used herein are not intended to be limited to physical tags or markers attached to articles to be authenticated but are intended to also include invisible or covert features inherent in an article itself.

### BRIEF DESCRIPTION OF THE DRAWINGS

The present invention will be described by way of example only with reference to the following drawings, of which:

FIG. 1 is a block diagram of a brand protection management system;

FIG. 2 is a schematic of an authentication instrument for use with a brand protection management system;

FIG. 3 is a schematic of an alternative authentication instrument for use with a brand protection management system;

FIG. 4 is a schematic of a process for initializing a security tag using the instrument of FIG. 2;

FIG. 5 is schematic diagram of a workflow splitter for use in the system of FIG. 2;

FIG. 6 illustrates a method for splitting a workflow, and

FIG. 7 shows an example workflow.

### DETAILED DESCRIPTION OF THE DRAWINGS

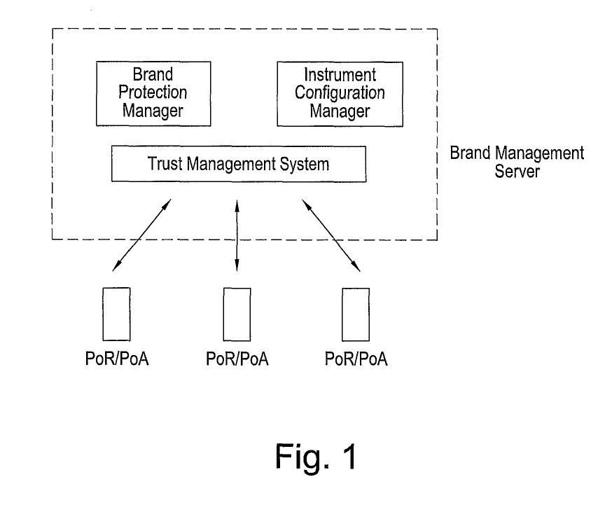

FIG. 1 shows a brand protection management system in accordance with the teachings of PCT/GB2007/001248. This has a brand management server that can communicate with point of registration (PoR) brand protection feature reader/writer devices and point of authentication (PoA) reader devices provided at various locations in a product distribution chain. The reader devices include brand protection feature readers for reading brand protection features/taggants on articles that are to be authenticated. Such taggants may, for example, include barcodes, of one dimensional or two dimensional type, RFID tags, fluorescent tags, or any other suitable taggant types. The reader devices may include user authentication devices such as, for example, smart card or biometric readers, for reading user identification information provided by a user for authentication purposes. In some cases the reader devices may also have a write capability so that they can generate brand protection features, e.g. taggants in labels, as well as read them. For example, the PoR devices are capable of generating brand protection features to be applied to new, that is not previously authenticated, articles, at a start, or registration point.

The PoR and PoA devices communicate with the brand protection management server system using whatever standard communication method is most appropriate for them, e.g. TCP/IP over LAN for fixed devices, or WiFi for portable devices or GSM etc. One or more PoR reader/writer devices may be linked/served using local networking such as WiFi or Ethernet, to a single Point of Registration (PoR) control device, e.g. a client Personal Computer (PC). Similarly several PoA devices may be linked/served in a similar manner by a main PoA device, e.g. a client personal computer (PC). In the description below references to the “PoA/PoR instrument” shall be understood to mean a PoA device or a PoR device or a single instrument in which a PoR device and PoA device are combined.

Included at the brand protection server is a trust management system (TMS) for ensuring security across the entire platform and a brand protection management system for analysing and storing brand management data, and controlling brand related features or functions. Also provided at the server is an instrument configuration management system (ICMS) for managing policies for control of each PoR and PoA instrument in the system. The policies include control or configuration information specifying, for example, the type of brand protection feature that is to be read, the type of processing that is to be used to authenticate a particular brand protection feature, the grade or role of user approved to use the reader, the workflow; that is the steps that a user who is operating the reader has to take; and any other brand protection feature reader information. A detailed description of workflows is provided in PCT/GB2007/002967, the contents of which are incorporated herein by reference. Included in the ICMS is a component of the trust management system, typically implemented on a Hardware Security Module (HSM) or Secure Access and Authentication Module (SAAM) or some other tamper proof security component.

Data flows from the central TMS via this to the instruments in the field. To ensure local security, each PoR and PoA device includes its own trust management system component.

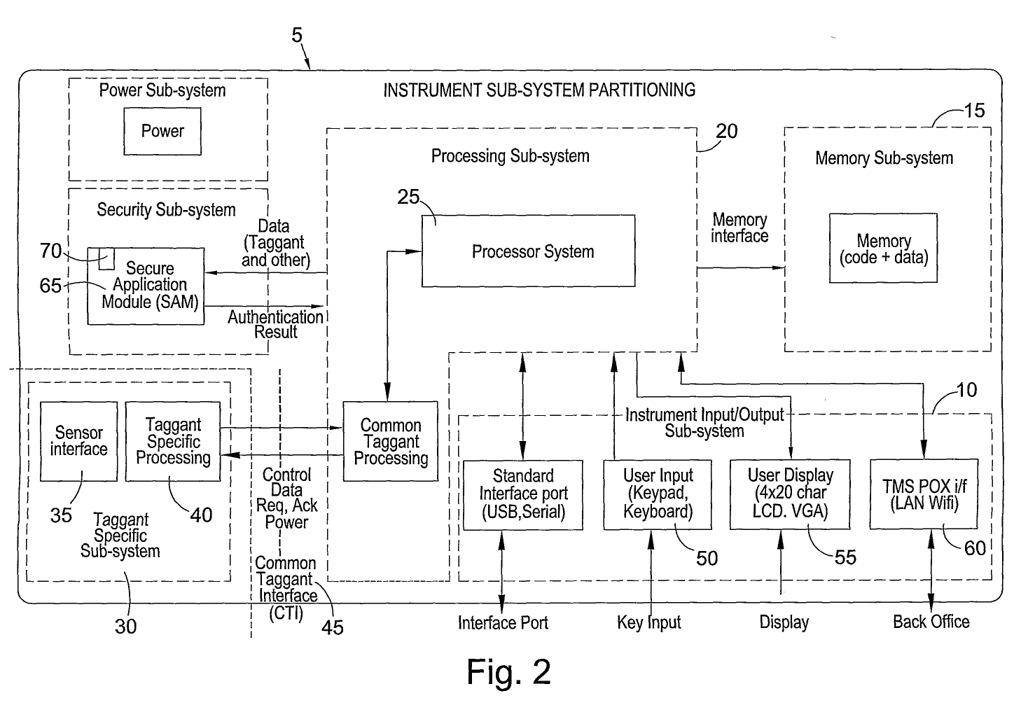

FIG. 2 illustrates an instrument 5 for use with a brand protection management system (BPMS). The instrument 5 is operable to interact with secure tags on goods or resources on behalf of the BPMS. The instrument 5 includes an input/output module 10, a memory 15, a core processing subsystem 20 that has a core processor 25 for controlling all processing operations in the instrument 5; a tag specific feature extraction and configuration block 30 and a security subsystem that has a secure application module (SAM) for storing, handling and/or processing sensitive information. Also provided is a power subsystem for powering all components of the device.

The input/output module 10 has a user input 50, which may be, for example, a keypad, smart card slot or biometric scanner and a user display 55. The instrument 5 is provided with an interface 60, which may, for example, be LAN or WiFi, for communicating with the TMS, which is typically physically located on a different geographical site to the instrument. The instrument storage facility 15 includes a data store for converted authentication data and a data store for configuration data, which sets the configuration of the brand protection feature extraction module 30. The configuration details include product IDs, authentication events, their parameters, their sequencing, what tag technologies are to be used, and whether there is a link between data read from one brand protection feature and another on the same product. The configuration data is downloaded to the instrument from the instrument configuration manager.

The tag specific feature extraction and configuration block 30 contains a sensor interface 35 and a tag specific processor 40. The sensor could, for example, be a barcode scanner, an RFID tag reader or any other chosen machine-readable tag reader and/or writer device. The sensor interface 35 and tag specific processor 40 control the sensor and process the data exchanged with the sensor to read from and/or write to a tag in order to extract identification information relating to the tag and/or to configure the tag. Data extracted from the tag is converted into a common platform format by a common brand protection feature interface 45 for communication to the rest of the instrument components and vice versa for communications from the instrument to the tag.

In order to maintain security, the instrument 5 includes a secure application module (SAM) for processing and controlling the communication of authentication data between the tag reader and brand protection management server. The SAM provides a physically and logically secure module for storing authentication information and/or at least partially processing authentication requests. The SAM 65 acts as a trust management agent for the BPMS and is adapted to process and store secure information for authenticating tags using, for example, tag features that have overlapping verifiable content, such as an encrypted check, for example, a MAC or digital signature. Generally speaking, the SAM is an execution environment with limited memory and computing power.

The SAM 65 may be, for example, a smart card. There is a well defined set of specifications for SAMs and other Integrated Circuit Cards (ICC) that detail the electrical signals, communications protocols and Application Protocol Data Units (APDUs) that all such modules should be compatible with. The relevant ISO 7816 specifications are detailed in the following references: ISO/IEC ISO 7816-1, Identification cards—Integrated circuit(s) cards with contacts—Part 1: Physical characteristics, 1998 (Amendment 2003); ISO/IEC ISO 7816-2, Identification cards—Integrated circuit cards—Part 2: Cards with contacts—Dimensions and location of the contacts, 1999 (Amendment 2004); ISO/IEC ISO 7816-3, Information technology—Identification cards—Integrated circuit(s) cards with contacts—Part 3: Electronic signals and transmission protocols, 1997 (Amendment 2002); ISO/IEC ISO 7816-4, Identification cards—Integrated circuit cards—Part 4: Organization, security and commands for interchange, 2005; ISO/IEC ISO 7816-8, Identification cards—Integrated circuit(s) cards with contacts—Part 8: Commands for security operations, 2004, and ISO/IEC ISO 7816-11, Personal verification through biometric methods, 2004.

When the instrument of FIG. 2 is in use as an authenticating device, the user identifies themselves and the type of tag that is to be used, so that the tag specific processor 40 is able to identify the processing needed for the tag that is about to be scanned. The scan results in a representative signal in the sensor interface 35, which is communicated to the tag specific processing module 40 for tag specific first level processing and extraction of tag features. The tag signal is converted into the common data format and sent to the SAM 65 for examination for authenticity, thereby to provide off-line authentication of the tag.

The process of authenticating a tag involves three stages: using a reader instrument to convert physical phenomena into an electrical signal that can be processed; filtering or converting that signal to produce a verifiable output and verifying that output against some predefined criteria. In many cases, the security effectiveness of an anti-counterfeiting feature comes from maintaining the secrecy or covertness of the details of the processing performed in second stage. To ensure this, and in accordance with the invention, the authentication process is partitioned into secure and non-secure functions according to the availability and capability of secure processing components in the reader instrument, with all or as many as possible key security functions being implemented in the trusted environment of the SAM.

To illustrate the secure partitioning process, consider the authentication of a linear bar code that includes covert second order effects, as described in co-pending international patent application PCT/GB2007/002496, the contents of which are incorporated herein by reference. A conventional linear bar code has a plurality of bars and spaces of varying width, the width being a multiple of a unit width X. The bars and spaces can be decoded using a bar code scanning device, thereby to reveal primary data. Each bar is rectangular and has a pre-determined, uniform height. In accordance with the teachings of PCT/GB2007/002496, additional or second order information can be embedded in a conventional bar code by varying the overall shape of at least one of the bars, for example, by varying the width of the bars by an amount that is not a multiple of the unit width X. In this way secondary information can be encoded into the bar code. Variations in the shape of the bars have to be such that they do not affect the ability of a standard barcode reader to read the primary data, but sufficient to convey secondary information and preferably are indiscernible by eye.

The main steps of decoding an image with the second order effect are the same irrespective of the modulation, these being decode of the primary data, which is the read of the two-dimensional data matrix, and decode of second order effect embedded within that matrix. From a security viewpoint, the area of concern is the data extraction and subsequent processing of the second order effect modulated data. If this is performed in an observable manner or indeed on a platform that is exposed to direct manipulation of key data values, then the offering is exposed to a number of attack classes, including observation of key processes and their operation; determination of critical security parameters, for example observation of threshold values; opportunity to exploit denial of service attacks and opportunity to bypass the processing entirely by insertion of previously recorded data at key points.

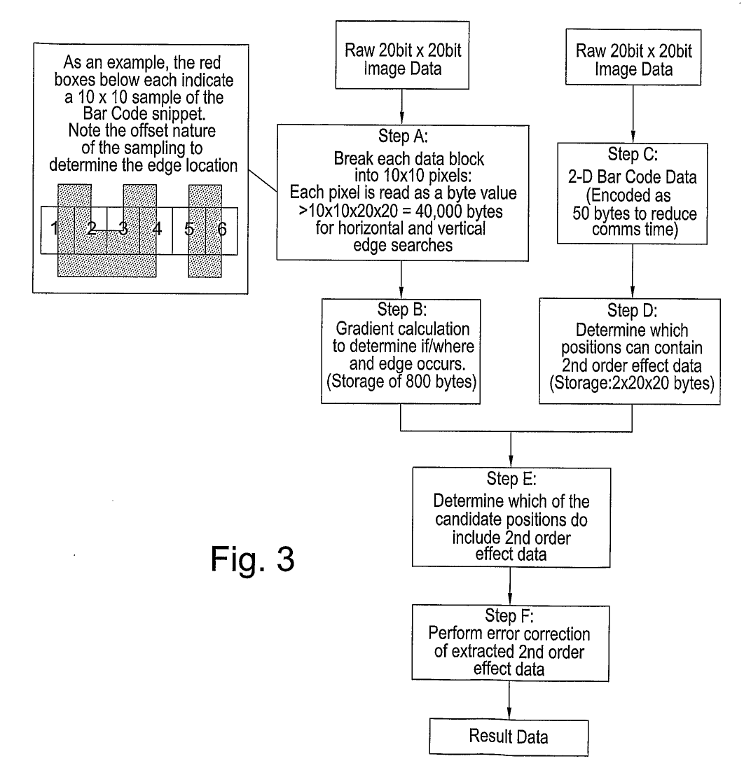

FIG. 3 shows the steps involved in reading a bar code having a second order effect. In this case, secondary information is embedded within the bar code by varying the width of the bars by an amount that is different from the unit width used for the primary data. Once the bar code is read, a greyscale value is produced for each point and a gradient calculation performed to determine the point at which a block truly changes from black to white, see steps A and B. This is the edge determination part of the analysis. At the same time, the primary data is decoded, see step C. From this data, the position of blocks that can hold second order effect data are determined, see step D. Where the decoding operation forks join, step E, the image positions that can contain second order effect data are checked to determine if they actually contain second order effect data. In its most basic form, this could be performed by a simple compare against an internally stored, secret threshold value. If no second order effect is detected, that is interpreted as a logical bit 0. If a second order effect is detected, then that is interpreted as a logical bit 1. This detection applies to both horizontal and vertical blocks. Once the bits are decoded, any error correction applied can be decoded to reduce the bit error rate in the result data, see step F.

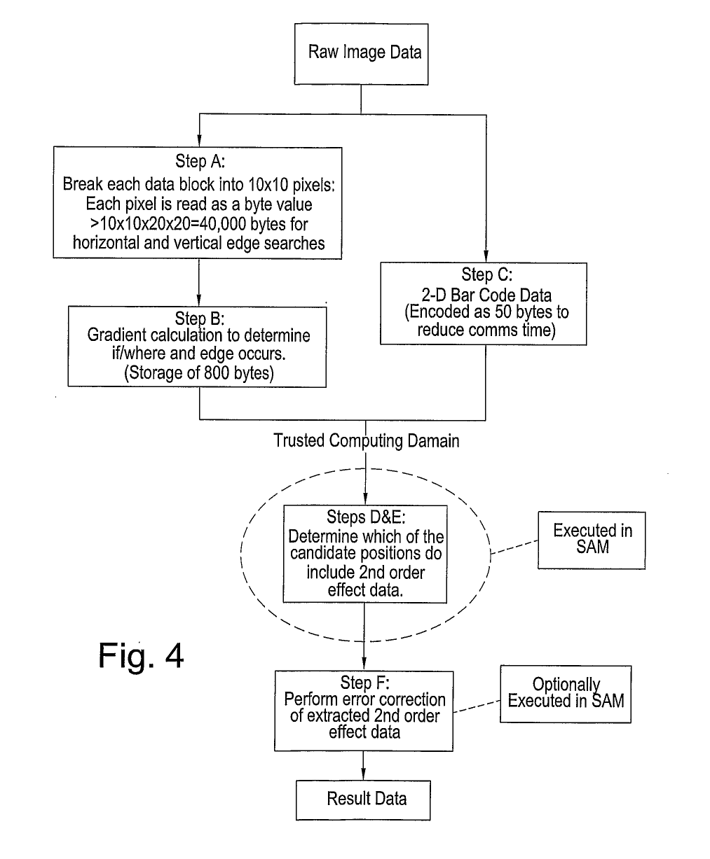

In order to improve the security of the process of FIG. 3, selected steps are implemented in the SAM, as shown in FIG. 4. This first of these is the determination of the positions within the primary data at which the second order effect could be encoded, i.e. step D. The other step that is ideally implemented in the SAM is the determination of the positions within the primary data at which a second order effect has been encoded, i.e. step E. Error correction of the data may also be implemented in the SAM, i.e. step F. If it were, then the final result data would not need to leave the environment of the SAM and so if, for example, this data is actually part of the securing digital signature or MAC for the primary data, then the authentication of the tag via the second order effect is entirely encapsulated within the trusted computing domain. By hiding the calculation of which blocks can contain secondary data and the determination of which bits do contain data, as well as optionally the error correction data, the attacker is deprived of key information as to how the brand protection feature is operating.

In the anti-counterfeiting system of FIG. 1, the PoAs and PoRs may vary. For instance, as shown in FIG. 2, some may have SAMs and some may not. Equally, some may have smart cards with different processing capabilities. The ICMS has a record of the capabilities of each instrument and can select a different partitioning of any process into secure and non-secure parts, depending on the instrument capabilities. For instance, the instrument may have a fully secured, high capability processor. In this case, the process is not partitioned or all partitioned steps are regrouped and downloaded onto the secure processor. In another case, the instrument may have a high powered smart card capable of running all security enforcing steps, but not the complete process, and so the algorithm may be partitioned into security enforcing and non-security enforcing steps and the instrument configured accordingly. In yet another example, the instrument may include a smart card capable of enforcing some, but not all, of the security enforcing steps. By allowing the ICMS to configure PoRs and PoAs according to stored configuration information, a single anti-counterfeiting feature can be supported using optimised reader instruments with only the required level of security enforcement.

Partitioning steps that are carried out by the PoR and PoA devices into secure parts that are implemented in the secure SAM and non-secure parts that are carried out in a less secure processing environment 20 can have many uses. For example, partitioning can be used when the PoR and PoA devices are being used in accordance with workflows that have to be authenticated and verified. Details of workflow assurance techniques are described in detail in co-pending international patent application PCT/GB2007/001248, the contents of which are incorporated herein by reference.

Workflows or executable policies are created in the BMPS using workflow and instrument configuration information provided by the ICMS. Once a workflow or policy is deployed to an instrument it is desirable to ensure that it cannot be altered maliciously. To enforce this, designated steps of the workflow, including for example, authentication of a scanned tag can be assigned to the SAM. Other non-secure steps are implemented on the general purpose processor 25. The configuration management of the workflow assuring entity enforces key steps by validating that an operation is being performed at the correct stage of a predefined process. This provides a mechanism for indicating that a violation has occurred if the incorrect sequence is followed either accidentally or intentionally.

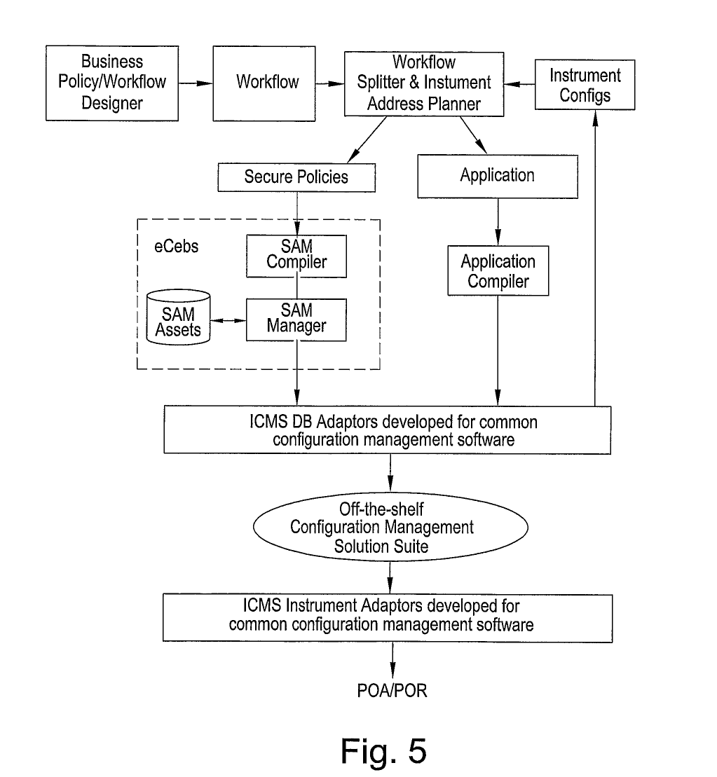

To partition a workflow, a security specification is created by a workflow splitter, as shown in FIG. 5. For any input policy/workflow the splitter can compute a series of specifications that are a transformation of the policy into a new representation that includes instructions for a hardware security module (SAM) running on a PoA/PoR, so that the policy can be split or partitioned into secure and non-secure portions according to pre-determined instrument configurations. Preferably, the workflow splitter processes the workflow so that valid sequences of secure primitives can be identified when a workflow is running on an instrument. The secure and non-secure portions of the process are then labelled for implementation in the appropriate area of the instrument.

Once the workflow is split, the ICMS processes the policy to ensure that it is in an appropriate form or version for the target instruments. The policy is then returned to the BPMS and sent to one or more selected PoR and/or PoA devices and downloaded, with the secure steps of workflow procedures being embedded within the SAM, and the non-secure steps located in the general processing environment 25.

When a workflow is deployed in an instrument instructions for the workflow are displayed to guide the operator through the procedures. All the key workflow events are captured and sent to the BPMS either immediately or as part of a batch transfer at a later time. At various points in the execution of the workflow, secure primitives are called on the SAM. Executing these secure primitives on the SAM provides one level of security as the SAM encapsulates the secure primitive in an environment with financial grade security. The secure primitives include capabilities to verify brand protection features and to securely transmit verification events to a remote BPMS.

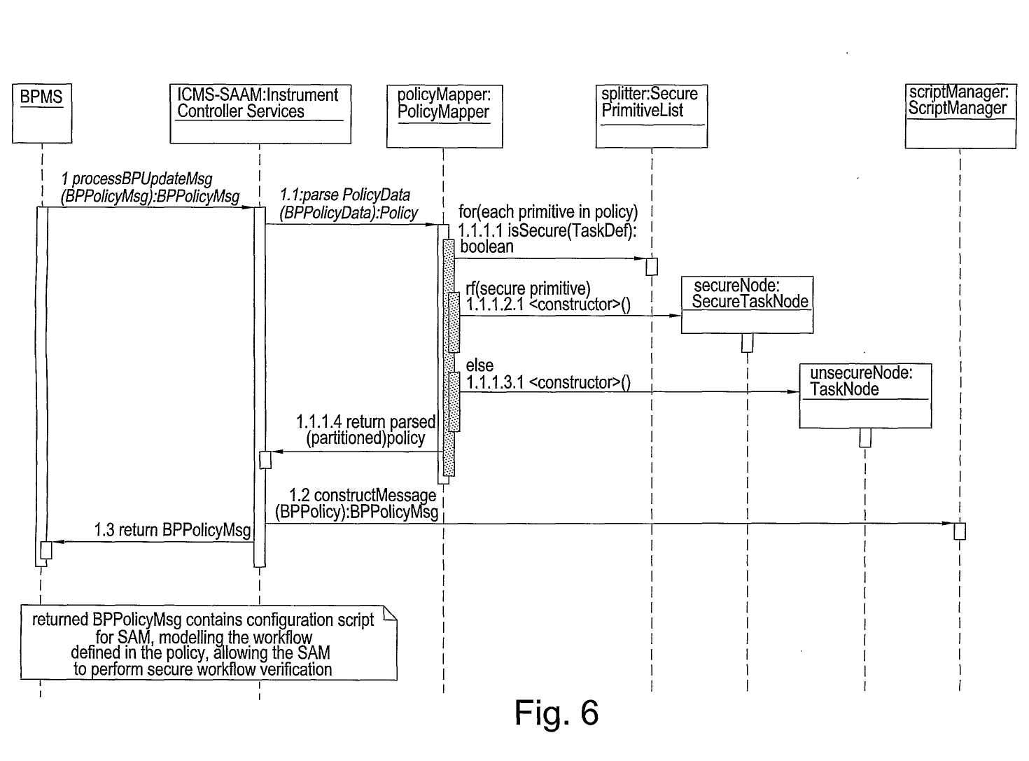

FIG. 6 shows the method for splitting a workflow in more detail. A message is sent to the ICMS-SAAM by the BPMS that has created the workflow policy. The message contents are an XML representation of the workflow policy, which may or may not match the internal representation of the ICMS-SAAM. Where translation is needed, a policy mapper is used. This has functionality can be extended to allow the use of technologies other then XML for the policy interchange. Each primitive in the policy is processed, checking if it is a secure primitive or not against a predefined set of secure primitives. The assumption is that the policy has been constructed using the secure primitives previously defined by the ICMS-SAAM.

If a secure primitive is detected (at step 1.1.1.2.1), it is mapped to a SecureTaskNode within the ICMS-SAAM policy. If a non-secure primitive is detected (at step 1.1.1.3.1), it is mapped to a TaskNode within the ICMS-SAAM policy. Having identified the secure and unsecured nodes, the ICMS-SAAM produces a configuration script for the workflow assurance enforcing entity within the instrument. In this example, as shown at step 1.2, the partitioned policy containing SecureTaskNodes and TaskNodes is passed to the ScriptManager to be converted into a configuration script for the SAM within the instrument. When this script is then transferred to the instrument's SAM, it builds the appropriate security enforcing data values that are used during policy execution to ensure the correct workflow is being followed.

When a secure primitive step is detected within a policy, a call is made to the trust agent module to inform the SAM that the policy wishes to assert that a certain point of the policy has been reached. This is effectively the state management of secure aspects of the workflow policy. The SAM can validate this in a number of different ways. For example, it could validate a certain parameter passed to the module to ensure that it is within a previously determined allowed range or is even a sensible value for the measurement taken for example or the authentication of a digital signature or message authentication cryptogram (MAC). It could also involve validation of biometric data of the user or other user authentication data such as a PIN value to ensure that they are allowed to perform the step. The next step is the execution of the secure primitive itself. This may have further authentication data associated with it gathered from an earlier stage in the process or it may simply be a request to perform an operation that is deemed sensitive, such as the generation of a BPF. This is the key workflow assuring step as it is the internal checking performed by this command, based on the previous node assertions and any other data passed during the primitive execution call that is used to determine if the SAM will produce the requested data/result.

The instrument must supply an identifier for the policy node that owns a call to a secure primitive. The SAM uses this identifier to create a current node description by concatenating a token representing the current secure primitive to the current node ID. The SAM maintains a hashtable or other suitable data structure containing a mapping from the current executing node description secure primitive to a set of the possible precursor node descriptions. A node is defined as consisting of the name of a secure primitive concatenated with the unique identifier for a node as defined in the policy. At runtime the SAM must hold a ‘last node’ variable and a ‘last secure primitive’ variable. Each time a call is made to the SAM it checks whether the concatenation of the last secure primitive and last node identifier is a valid precursor for the current node description by looking up the set of valid node descriptions in the data structure/hashtable.

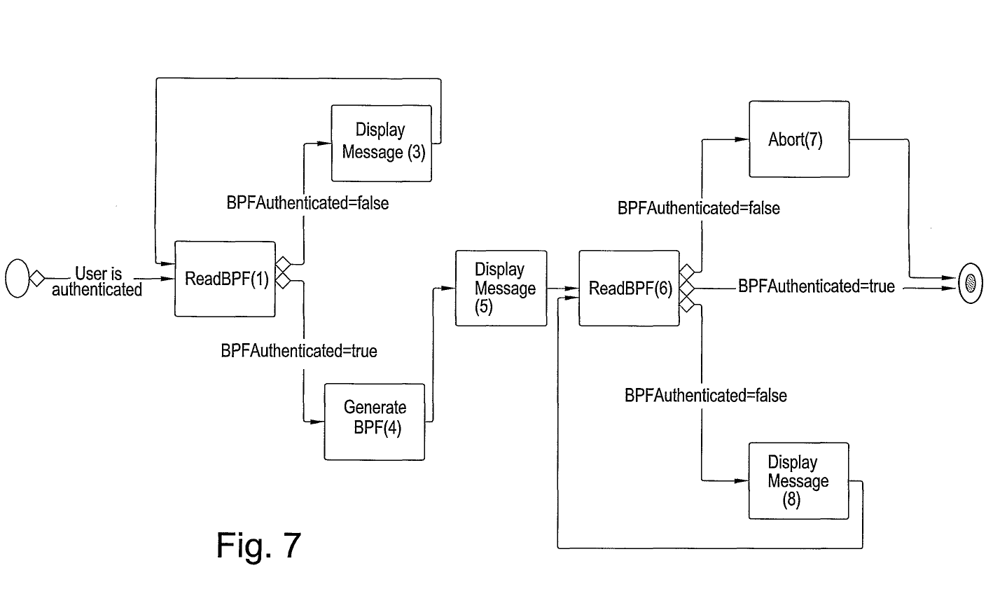

FIG. 7 shows an example of a workflow. In order to provide assurance that the workflow running matches the SAM's configured policy certain key sequences of events have to be secured. Where a PoR or PoA is able to read and write taggants, one of these is the following node descriptions: ReadBPF[1] and GenerateBPF[4]. The GenerateBPF[4] step is the secure primitive call which the end user would see as the printing of a label. It should never be possible to print the label unless a ReadBPF[1] was performed. Consider a case where the policy can be maliciously hacked such that the initial ReadBPF[1] node is removed. Such a policy would enable a counterfeiter to introduce an unlimited number of packages into the distribution chain without an association to an existing package. When executing the GenerateBPF[4] step, as long as the SAM knows that GenerateBPF [4] is only legal if the previous command was ReadBPF[1], it can reject the execution of this hacked policy. In order to distinguish different calls, a node Id is appended to the name of the primitive that is being executed. So ‘GenerateBPF’ has the node id 4 appended.

To ensure that workflow steps are carried out in a specified order, the policy is processed such that for each secure primitive encountered all possible node descriptions are backtracked from each node corresponding to a secure operation. Hence, as an example,

For ReadBPF[1] only Start[0] is possible
for GenerateBPF[4] only ReadBPF[1] is possible
for ReadBPF[5] only PrintLabel[1] is possible

This comprises a small set of transition constraints that must remain true. Since these are stored in the secure processing environment, this specified order is secured and any deviation from is will indicate a violation of the workflow.

The list of preconditions can be stored in a look up table with the current node as the key, however the values of the look up table would need to be arrays or collections for the general case, in the example these are single member sets such as {“start[0]”}, eg: where the lookup table is a hashtable:

```
Hash constraints = {
  “ReadBPF[1]” = {“Start[0]”},
  “ PrintLabel[2]” = {“ReadBPF[1]”},
  “ReadBPF[5]” = {“GenerateBPF[4]”}
```

In a circumstance where there are more possible precursors to a given node then we would see something like this for a hashtable entry.

### “ReadBPF[5]”={“PrintLabel[1], “ReadBPF[2]”}

This would mean that either “PrintLabel[1]” or “ReadBPF[2]” were valid precursors for “ReadBPF[5]”

Assuming all secure methods are called by a method with the following signature

execSecurePrimitive(primitiveName, args, nodeldentifier)

Then in pseudocode this would be

```
execSecurePrimitive(primitiveName, args, nodeIdentifier) {
  String [ ] allowableNodes = constraints.get( primitiveName + “[” +
nodeIdentifier + “]” );
  if (lastRecordedOperation is not in allowableNodes ) {
    raise a workflow verification exception
}
else {
  exec(primitiveName, args);
  lastRecordedOperation = primitiveName + “[” + nodeIdentifier + “]” ;
}
}
```

When the workflow verification exception is raised, the instrument is informed of the violation of workflow sequence and may then take appropriate steps to disable a policy and transform events to the BPMS or to another system such that it is possible to inform a supervisor that there is a potential security violation to investigate.

A skilled person will appreciate that variations of the disclosed arrangements are possible without departing from the scope of the invention. Accordingly the above description of the specific embodiment is made by way of example only and not for the purposes of limitations. It will be clear to the skilled person that minor modifications may be made without significant changes to the operation described.

1. A brand protection feature/taggant reader and/or writer instrument comprising a secure processing environment and a non-secure processing environment, the instrument being operable to execute a process that is split between the secure and non-secure environments in accordance with pre-defined criteria.

2. An instrument as claimed in claim 1 wherein the instrument being operable to execute the process, wherein the process is at least one of extraction or identification of a brand protection feature/taggant and issuing or registration of a brand protection feature/taggant.

3. An instrument as claimed in claim 2 wherein the instrument being operable to execute the process, wherein in the process extraction or identification of a brand protection feature/taggant is done in the secure processing environment.

4. An instrument as claimed in claim 1 further adapted to read or write a brand protection feature/taggant that includes hidden information/data.

5. An instrument as claimed in claim 4 adapted to read the brand protection feature/taggant and process it to determine potential locations for the hidden data, the processing being done in the secure environment.

6. An instrument as claimed in claim 4 adapted to read the brand protection feature/taggant and process it to identify the hidden data, the processing being done in the secure environment.

7. An instrument as claimed in claim 4 adapted to read the hidden data and process it to authenticate the brand protection feature/taggant.

8. An instrument as claimed in claim 1 the instrument being operable to execute the process, wherein the process is a workflow or a policy.

9. An instrument as claimed in claim 1 wherein the process comprises a plurality of steps that have to be carried out in a specified order, wherein the specified order is stored in the secure environment and the instrument is adapted to check the actual order in which steps are carried out against the securely stored specified order.

10. An instrument as claimed in claim 1 wherein the brand protection feature/taggant operated on by the instrument is machine readable.

11. An instrument as claimed in claim 1, wherein the operation of the instrument is at least one of: authentication of a brand protection feature or issuing or registration of a brand protection feature.

12. An instrument as claimed in claim 1 wherein the secure processing environment is tamper proof.

13. An instrument as claimed in claim 12 wherein the secure processing environment is fully encapsulated.

14. An instrument as claimed in claim 1 wherein the secure processing environment is removable from the instrument.

15. An instrument as claimed in claim 1 wherein the secure processing environment comprises a secure application module or a hardware security module.

16. An instrument as claimed in claim 1 adapted to read and/or write one or more of one dimensional or two dimensional bar codes; RFID tags; or fluorescent tags.

17. A method for improving security on a brand protection feature reader/writer instrument comprising partitioning a process for execution between a secure processing environment and a non-secure processing environment.

18. A method as claimed in claim 17 comprising partitioning the process using known information on the configuration of the instrument.

19. A method as claimed in claim 16 comprising downloading the process to the instrument.

20. A computer program, on one of a data carrier or computer readable medium, or a processor having code or instructions for partitioning a process for execution between a secure processing environment and non-secure processing environment.

21. A brand protection management system adapted to collect authentication data from brand protection feature/taggant reader and/or writer instruments, wherein each instrument comprises a secure processing environment and a non-secure processing environment, the instrument being operable to execute a process that is split between the secure and non-secure environments in accordance with pre-defined criteria.

22. A brand protection management system adapted to distribute a process for implementation on a taggant reader and/or writer instrument, the process being partitioned to execute partly in a secure environment on the instrument and partly in a non-secure environment.

23. A brand protection management system as claimed in claim 22 adapted for use with a plurality of different taggant reader and/or writer instruments, wherein different versions of the process are prepared, each version partitioned according to the capabilities of one of the types of instrument.
